(19) United States
(12) Patent Application Publication
(10) Pub. No.: US 2025/0358573 A1
(43) Pub. Date: Nov. 20, 2025

(54) ELECTROACOUSTIC TRANSDUCER AND METHOD FOR MANUFACTURING ELECTROACOUSTIC TRANSDUCER

(71) Applicant: Panasonic Automotive Systems Co., Ltd., Kanagawa (JP)

(72) Inventors: Ryo TSUNAKI, Osaka (JP); Akihiro YOGO, Mie (JP); Tetsuya KOYANAGI, Osaka (JP)

(73) Assignee: Panasonic Automotive Systems Co., Ltd., Kanagawa (JP)

(21) Appl. No.: 19/203,723

(22) Filed: May 9, 2025

(30) Foreign Application Priority Data
May 16, 2024 (JP) 2024-080412

(51) Int. Cl. H04R 9/02; H04R 7/18

(52) U.S. Cl. CPC H04R 9/025; H04R 7/18

(57) ABSTRACT

An electroacoustic transducer includes: a bobbin that is cylindrical; a voice coil that is wound around one end portion of the bobbin; a magnetic circuit that includes a tubular magnetic gap in which the voice coil is disposed; a frame to which the magnetic circuit is attached; a diaphragm that is connected to the bobbin and the frame; a flange portion that protrudes outward from an outer circumferential surface of the bobbin, between the voice coil and the diaphragm; and a damper that is connected to an outer circumferential surface of the flange portion and to the magnetic circuit or the frame.

### CROSS REFERENCE TO RELATED APPLICATION

The present application is based on and claims priority of Japanese Patent Application No. 2024-080412 filed on May 16, 2024.

### FIELD

The present disclosure relates to electroacoustic transducers, such as a loudspeaker that converts electrical signals into sound, a microphone that converts sound into electrical signals, and so on.

### BACKGROUND ART

Conventionally, as described in Patent Literature (PTL) 1, there is a loudspeaker in which a damper is connected to a bobbin to which a voice coil is attached. Furthermore, PTL 2 describes a loudspeaker in which a bobbin and a damper are integrally molded.

### CITATION LIST

### Patent Literature

PTL 1: Japanese Unexamined Patent Application Publication No. H09-307993
PTL 2: Japanese Unexamined Patent Application Publication No. H02-248200

### SUMMARY

However, the loudspeakers described in aforementioned PTL 1 and 2 can be improved upon.

In view of this, the present disclosure provides an electroacoustic transducer and a method for manufacturing the electroacoustic transducer that are capable of improving upon the related art.

An electroacoustic transducer according to an aspect of the present disclosure includes: a bobbin that is cylindrical; a voice coil that is wound around one end portion of the bobbin; a magnetic circuit that includes a magnetic gap in which the voice coil is disposed, the magnetic gap being tubular; a frame to which the magnetic circuit is attached; a diaphragm that is connected to the bobbin and the frame; a flange portion that protrudes outward from an outer circumferential surface of the bobbin, between the voice coil and the diaphragm; and a damper that is connected to an outer circumferential surface of the flange portion and to the magnetic circuit or the frame.

A method of manufacturing an electroacoustic transducer according to an aspect of the present disclosure is a method for manufacturing the electroacoustic transducer described above, and includes: forming the damper by filling, with resin, a space between a first mold component and a second mold component that are disposed sandwiching an entire circumference of the flange in a winding axis direction of the voice coil.

An electroacoustic transducer and a method for manufacturing the electroacoustic transducer according to an aspect of the present disclosure are capable of improving upon the related art

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a cross-sectional view of the internal structure of an electroacoustic transducer.

FIG. 2 is a perspective view of a bobbin, a voice coil, a flange portion, and a damper in an assembled state.

FIG. 3 is a cross-sectional view of the bobbin, the voice coil, the flange portion, and the damper in the assembled state.

FIG. 4 is diagram illustrating a first process of connecting the damper and the flange portion while molding the damper by injection molding.

FIG. 5 is diagram illustrating a second process of connecting the damper and the flange portion while molding the damper by injection molding.

FIG. 6 is diagram illustrating a third process of connecting the damper and the flange portion while molding the damper by injection molding.

FIG. 7 is diagram illustrating, from another angle, the first process of connecting the damper and the flange portion while molding the damper by injection molding.

FIG. 8 is a schematic diagram illustrating another example of a damper.

### DESCRIPTION OF EMBODIMENTS

Hereinafter, exemplary embodiments of an electroacoustic transducer and a method for manufacturing the electroacoustic transducer according to the present disclosure will be described with reference to the drawings. It should be noted that each of the subsequent embodiments shows an example for describing the present disclosure, and thus is not intended to limit the present disclosure. For example, the shapes, structures, materials, structural components, the relative positional relationships and connections of the structural components, numerical values, formulas, steps, the processing order of the steps, and so on, shown in the following embodiments are mere examples, and details not described below may be included. Furthermore, although there are cases where geometric expressions, such as “parallel” and “orthogonal”, are used, these expressions are not mathematically precise indications and include substantially permissible error, deviation, and the like. Moreover, expressions such as “simultaneous” and “identical (or the same)” are considered to cover a substantially permissible range of meaning.

Additionally, the drawings are schematic illustrations that may include emphasis, omission, or adjustment of proportion as necessary for the purpose of describing the present disclosure, and thus the shapes, positional relationships, and proportions shown may be different from actuality. Furthermore, the X-axis, Y-axis, and Z-axis which may be shown in the drawings are arbitrarily set rectangular coordinates for describing the figures. In other words, the Z-axis is not limited to an axis in the vertical direction, and the X-axis and Y-axis are not limited to being axes inside a horizontal plane.

Furthermore, hereinafter, multiple inventions may be comprehensively described as a single embodiment. Moreover, part of the contents described below is described as an optional element related to the present disclosure.

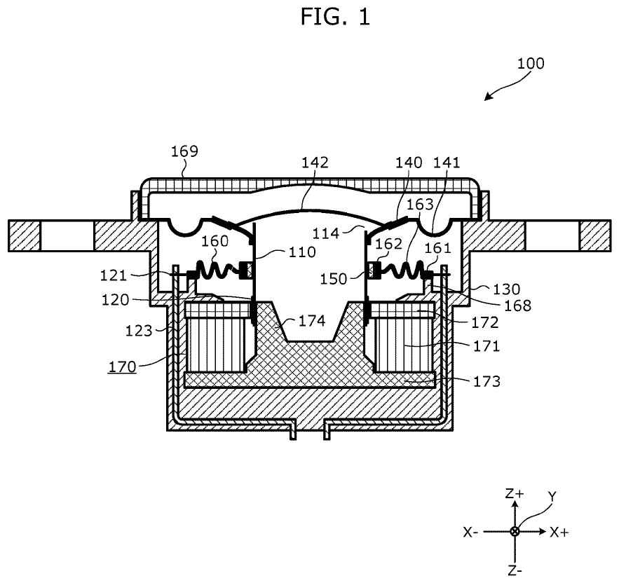

FIG. 1 is a cross-sectional view of the internal structure of electroacoustic transducer 100. In the present embodiment, a loudspeaker which is one type of electroacoustic transducer 100 will be described. The loudspeaker which is one type of electroacoustic transducer 100 is a device that generates sound based on an inputted electrical signal, and includes bobbin 110, voice coil 120, frame 130, diaphragm 140, flange portion 150, and damper 160. In the present embodiment, electroacoustic transducer 100 is exemplified as a loudspeaker that is attached to a mobile body such as an automobile. Electroacoustic transducer 100 is a small-sized electroacoustic transducer capable of being buried in a limited space inside the mobile body. It should be noted that, in the present Specification, there are cases where small-sized is used to refer to electroacoustic transducer 100 that includes diaphragm 140 having a diameter of 10 cm or less. It should be noted that the intended use and size of electroacoustic transducer 100 are not limited to the above.

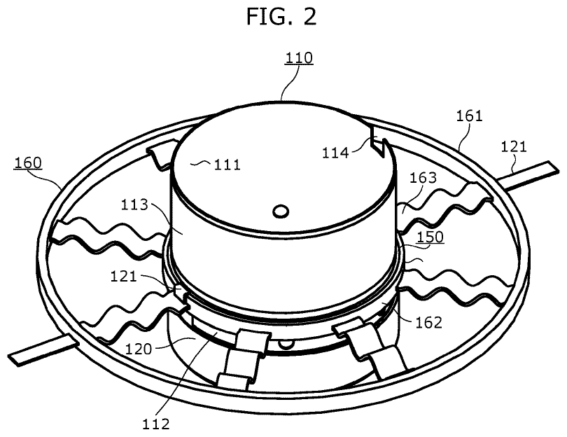

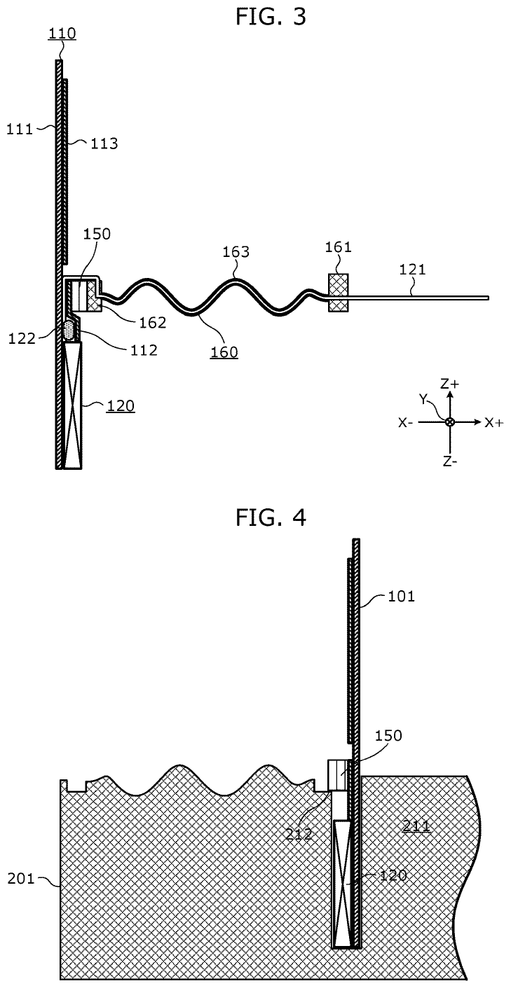

FIG. 2 is a perspective view of bobbin 110, voice coil 120, flange portion 150, and damper 160 in an assembled state. FIG. 3 is a cross-sectional view of bobbin 110, voice coil 120, flange portion 150, and damper 160 in the assembled state. Bobbin 110 is a cylindrical component that holds voice coil 120 which is wound around the outer circumferential surface of one end portion of bobbin 110, and is connected to diaphragm 140 via the outer circumferential surface of the other end portion of bobbin 110. Although the shape, structure, material, and so on, of bobbin 110 is not intended to be limited, in the present embodiment, bobbin 110 includes inner component 111, first outer component 112, and second outer component 113.

Inner component 111 is a thin-walled, cylindrical component. The material making up inner component 111 can be exemplified by a relatively light metal such as aluminum or an aluminum alloy, a resin such as polyimide, or the like. Mark 114 is provided in the other end portion of at least one of inner component 111 and second outer component 113 (both, in the present embodiment) in the winding axis direction (Z-axis direction in the figures) of voice coil 120, which is the end portion on the opposite side of the one end portion to which voice coil 120 is attached. Mark 114, which is provided in one part in the circumferential direction of the other end portion, is a cutout, a hole, or the like, and is different from the remaining part in the circumferential direction. Diaphragm 140 is attached to the outer circumferential surface of bobbin 110 between mark 114 and flange portion 150. With this, even if mark 114 is structurally different from the remaining part in the circumferential direction, mark 114 does not negatively affect the connection between diaphragm 140 and bobbin 110.

First outer component 112 is a cylindrical component disposed on the outer circumferential surface-side of inner component 111, and is arranged closer to voice coil 120 than second outer component 113 is. Connecting components 121 are arranged between first outer component 112 and inner component 111. Connecting components 121 are conductors that are electrically connected to the opposite end portions of voice coil 120. Connecting components 121 are arranged to pass between inner component 111 and first outer component 112, and pass through a gap between first outer component 112 and second outer component 113.

In the present embodiment, each connecting component 121 is inserted through the inside of damper 160, and protrudes outward from the outer circumferential edge of damper 160. First outer component 112 also covers connection 122 between voice coil 120 and connecting component 121. For example, connection 122 is the portion where the pair of end portions of voice coil 120 and a pair of connecting components 121 are connected, respectively, using solder. The material of first outer component 112 is not limited but, in the present embodiment, first outer component 112 is configured from paper such as Kraft paper.

Second outer component 113 is a cylindrical component that is disposed, spaced apart from first outer component 112, at a position on the outer circumferential surface-side of inner component 111 and closer to diaphragm 140 than to voice coil 120. The material of second outer component 113 may be the same as or different from the material of first outer component 112. In the present embodiment, like first outer component 112, second outer component 113 is configured from paper such as Kraft paper.

Voice coil 120 is a component that is wound around the end portion of bobbin 110 that is far from diaphragm 140. Voice coil 120 is a component that is disposed inside a magnetic gap of magnetic circuit 170, generates a magnetic flux based on an inputted electrical signal, and vibrates in the winding axis direction (Z-axis direction in the figures) due to the interaction with the magnetic flux generated by the magnetic circuit 170. The material of voice coil 120 is not limited as long as it is a conductor, and, in the present embodiment, voice coil 120 is configured by winding a single metallic wire rod into a loop multiple times (to obtain a cylindrical shape).

Magnetic circuit 170 is a device that generates a steady magnetic flux that interacts with the magnetic flux generated by voice coil 120, and includes a tubular magnetic gap in which voice coil is disposed. The magnetic gap is an air gap in which a steady magnetic flux is generated in a direction that crosses with the magnetic flux generated by voice coil 120. Magnetic coil 170 is integrally attached to frame 130 so as to be located behind diaphragm 140 (in the “Z−” side in the figures).

In the present embodiment, magnetic circuit 170 is of the outer magnet type and includes a circular ring-shaped (circular cylinder-shaped) magnet 171 disposed on the same axis as the winding axis of voice coil 120, circular ring-shaped front surface plate 172 disposed on the same axis as the winding axis of voice coil 120, in the diaphragm 140-side surface of magnet 171, and back surface component 173 disposed on a back surface side which is the side opposite to front surface plate 172 with respect to magnet 171. Back surface component 173 is a component referred to as a so-called yoke, and so on, and includes a center pole 174 that is inserted into the through hole of front surface plate 172 from the center portion to form a magnetic gap with front surface plate 172. Back surface component 173 and center pole 174 are integrally formed.

Front surface plate 172 and back surface component 173 including center pole 174 are configured from a magnetic material. For magnet 171, it is preferable to use, for example, a neodymium-based magnet having high magnetic energy. Accordingly, the thickness of magnet 171 can be made thin, and the thickness of electroacoustic audio transducer 100 can be made thin. In addition, weight-reduction can be achieved. Furthermore, an outer magnet type structure using a ferrite magnet may also be adopted.

Frame 130 is a component that holds magnetic circuit 170 and holds diaphragm 140 via edge 141. In the present embodiment, frame 130 is integrated with transmission member 123 by insert molding. The overall shape of frame 130 is a bottomed cylindrical shape, and cover 169 is attached on the side opposite to magnetic circuit 170.

A circular ring-shaped damper attachment portion 168 to which the outer circumferential portion of damper 160 is attached is provided integrally on the inner side of frame 130. Damper attachment portion 168 is provided on the same axis as the winding axis of voice coil 120 and protrudes toward the front from the front side of magnetic circuit 170.

The material making up frame 130 is not particularly limited, and can be exemplified by a resin such as polycarbonate, and the like.

Diaphragm 140 is a component to which bobbin 110 is connected, and which, by being displaced in the forward and backward direction (Z-axis direction in the figures) with respect to a neutral position, based on the vibration of voice coil 120, causes air to vibrate to thereby generate sound. In the present embodiment, the outer circumferential portion of diaphragm 140 is connected to frame 130 via edge 141 which has flexibility and restorability, and is stretched between bobbin 110 and frame 130. A through-hole through which bobbin 110 is inserted is provided in the center portion of diaphragm 140, and the through-hole and the opening of bobbin 110 on the diaphragm 140-side is closed by cap 142.

It should be noted that the shape of diaphragm 140 is not particularly limited, and may be exemplified as a cone shape, an elliptical cone shape, or a pyramid shape, and may be a flat shape such as a disk, an elliptical disk, a flat board, or the like. The material making up diaphragm 140 is not particularly limited, and paper, resin, metal, and so on, may be given as an example.

Flange portion 150 is a portion that protrudes outward from the outer circumferential surface of bobbin 110, between voice coil 120 and diaphragm 140. The shape of flange portion 150 is not particularly limited and, in the present embodiment, is a circular ring-shape having a rectangular cross section when flange portion 150 is cut along a plane including the winding axis. Flange portion 150 may integrated with bobbin 110 or may be separate from bobbin 110. When flange portion 150 and bobbin 110 are separate pieces, the material of flange portion 150 is not limited. In the present embodiment, flange portion 150 is formed by winding a strip of paper, such as Kraft paper, around the outer circumferential surface of first outer component 112. It should be noted that the winding start portion of flange portion 150 is connected to first outer component 112 by an adhesive and the winding end portion of flange portion 150 is also fixed using adhesive. When flange portion 150 is formed using paper, the bonding strength between flange portion 150 and damper 160 can be improved since the surface of flange portion 150 to which damper 160 is to be connected is napped (fuzzy).

The amount by which flange portion 150 protrudes from the outer circumferential surface of bobbin 110 is not limited. In the present amendment, the amount of protrusion of flange portion 150 is greater than the amount by which voice coil 120 protrudes from the outer circumferential surface of bobbin 110. In other words, flange portion 150 protrudes outward more than voice coil 120 does. In the present embodiment, connecting component 121 is arranged so as to pass between bobbin 110 and flange portion 150.

Damper 160 is a component that is connected to the outer circumferential surface of flange portion 150 and to magnetic circuit 170 or frame 130, and assists the linear movement of voice coil 120 in the front-back direction (Z-axis direction in the figures). Although the shape of damper 160 is not limited, in the present embodiment, damper 160 includes outer ring portion 161, inner ring portion 162, and arm portions 163.

Outer ring portion 161 is a circular ring-shaped portion that is attached to damper attachment portion 168 of frame 130. In the present embodiment, the cross section of outer ring portion 161 is rectangular.

Inner ring portion 162 is a circular ring-shaped portion attached to the outer circumferential surface of flange portion 150, and is arranged concentrically with (i.e., on the same axis as) outer ring portion 161. In the present embodiment, the cross section of inner ring portion 162 is the same rectangular shape as that of outer ring portion 161.

Arm portions 163 are components that extend radially about the winding axis of voice coil 120, and connect, in a bridge-like manner, outer ring portion 161 and inner ring portion 162 which are arranged on the same axis as the winding axis of voice coil 120. It is sufficient that damper 160 includes at least two arm portions 163 and, in the present embodiment, damper 160 includes eight arm portions 163. Arm portions 163 are ribbon-shaped having a thickness in the front-back direction that is thin and a width in the radial direction that is wide, and are curved in the form of ripples centered on the winding axis direction of voice coil 120. With this, it is possible to ensure a long stroke for inner ring portion 162 which moves back and forth together with bobbin 110 with respect to outer ring portion 161. Stated differently, each of arm portions 163 include, in a continuous manner in the radial direction, hill parts that project toward the front side (the Z+ side in the figures) and valley parts that are recessed toward the back side (the Z− side in the figures). In the present embodiment, when the outer ring portion 161-side curve of one of adjacent arm portions 163 is a hill part, the outer ring portion 161-side curve of the other of the adjacent arm portions 163 is a valley part, and thus the patterns of the wavy shapes in the radial direction of adjacent arm portions 163 are in antiphase.

It should be noted that the shape of damper 160 is not limited, and although the width of one arm portion 163 is the same in the radial direction in the present embodiment, the width in the radial direction may differ so that arm portion 163 is fan-shaped, and so on.

Next, the method for manufacturing electroacoustic transducer 100 will be described. First, voice coil 120 is attached to and wound around one end portion of inner component 111 of bobbin 110 using a conventional method. Next, the opposite end portions of voice coil 120 and a pair of connection components 121 are connected using solder, or the like. Next, first outer component 112 and second outer component 113 are attached to predetermined locations of inner component 111. Next, flange portion 150 is attached to a predetermined position in first outer component 112. Hereinafter, the components manufactured up to this point will be referred to as sub-assembly 101.

Next, as illustrated in FIG. 4, sub-assembly 101 is inserted from the voice coil 120-side into first circular column portion 211 disposed at the center of first mold component 201. The circumferential direction positioning of sub-assembly 101 with respect to first mold component 201 is carried out based on mark 114 of bobbin 110. In the winding axis direction of voice coil 120, when about half of sub-assembly 101 is inserted into first mold component 201, the end surface of flange 150 on the voice coil 120-side and first sealing portion 212 of first mold component 201 abut with surface contact.

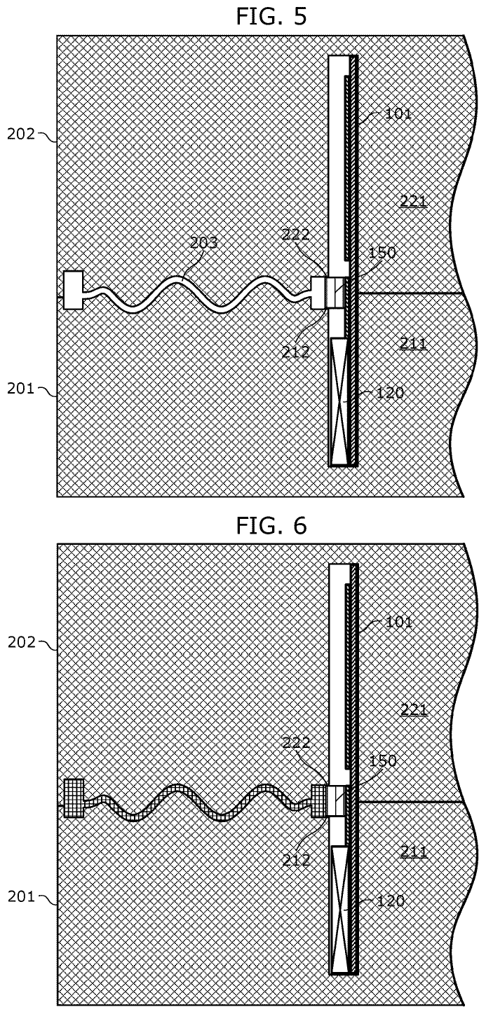

Next, as illustrated in FIG. 5, second circular column portion 221 disposed at the center of second mold component 202 is fitted onto sub-assembly 101. When second mold component 202 is fitted onto sub-assembly 101 until second mold component 202 abuts first mold component 201, the entire circumference of flange 150 is sandwiched between first sealing component 212 of first mold component 201 and second sealing component 222 of second mold component 202.

Next, as illustrated in FIG. 6, damper 160 is formed by filling, with resin, space 203 surrounded by first mold component 201, second mold component 202, and flange portion 150 (see FIG. 5). FIG. 4, FIG. 5, and FIG. 6 each illustrate a portion in which arm portion 163, in which connecting component 121 is not disposed, is formed. In the case of arm portion 163 in which connecting component 121 is disposed, connecting component 121 is disposed, and then resin is filled around connecting component 121, as illustrated in FIG. 7.

With the above-described processes, damper 160, which is connected to flange portion 150 attached to bobbin 110, is manufactured by insert molding. According to this manufacturing method, damper 160 can be almost automatically connected to bobbin 110 via flange portion 150 without manual work, and a product having minimal dimensional error can be steadily manufactured.

It should be noted that the present invention is not limited to the above-described embodiment. For example, other embodiments that can be realized by arbitrarily combining structural elements described in the present Specification or by removing some of the structural elements may be embodiments of the present invention. Furthermore, variations obtainable through various modifications to the above-described embodiment that can be conceived by a person of ordinary skill in the art without departing from the essence of the present invention, that is, the meaning of the recitations in the Claims are included in the present invention.

For example, electroacoustic transducer 100 is not limited to a loudspeaker, and may be a microphone that converts sound into electrical signals, and so on.

Furthermore, the shape of magnetic circuit 170 included in electroacoustic transducer 100 is not limited, and magnetic circuit 170 that is of an inner magnetic type can be employed.

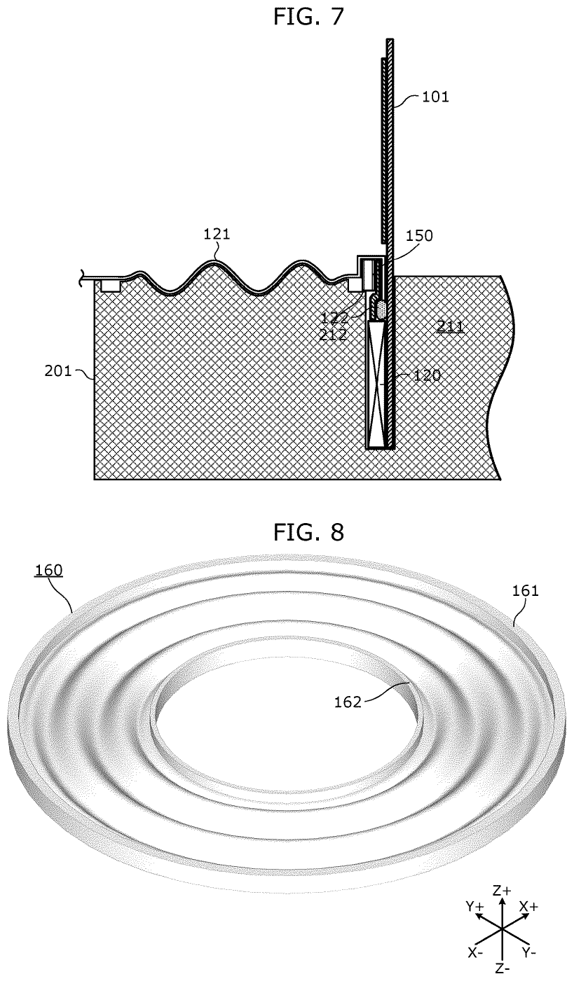

Furthermore, as illustrated in FIG. 8, damper 160 may be in a shape of a disk that has ripple-shaped curves and does not include arm portions 163.

Furthermore, although the case in which transmission member 123 is arranged inside frame 130 has been described, transmission member 123 may be arranged inside or outside of frame 130.

### Conclusion

Electroacoustic transducer 100 according to a first aspect includes: bobbin 110 that is cylindrical; voice coil 120 that is wound around one end portion of bobbin 110; magnetic circuit 170 that includes a magnetic gap in which voice coil 120 is disposed, the magnetic gap being tubular; frame 130 to which magnetic circuit 170 is attached; diaphragm 140 that is connected to bobbin 110 and frame 130; flange portion 150 that protrudes outward from an outer circumferential surface of bobbin 110, between voice coil 120 and diaphragm 140; and damper 160 that is connected to an outer circumferential surface of flange portion 150 and to magnetic circuit 170 or frame 130.

According to the first aspect, damper 160 can be easily connected to bobbin 110 via flange 150, and thus the precision of the attachment position of damper 160 can be improved.

Electroacoustic transducer 100 according to a second aspect is electroacoustic transducer 100 according to the first aspect, in which, flange portion 150 is made of paper.

According to the second aspect, the fuzziness, the gaps in the fiber, and the like, of paper can improve the bonding strength of flange portion 150.

Electroacoustic transducer 100 according to a third aspect is electroacoustic transducer 100 according to the first aspect or the second aspect, in which, the amount by which flange portion 150 protrudes from the outer circumferential surface of bobbin 110 is greater than the amount by which voice coil 120 protrudes from the outer circumferential surface of bobbin 110.

According to the third aspect, damper 160 can be easily connected to the outer circumferential surface of flange portion 150 which protrudes more than voice coil 120.

Electroacoustic transducer 100 according to a fourth aspect is electroacoustic transducer 100 according to any one of the first to third aspects, in which, mark 114 is provided in an other end portion of bobbin 110 in a winding axis direction of voice coil 120, the other end portion being on the opposite side of the one end portion of bobbin 110 at which voice coil 120 is attached, and diaphragm 140 is attached to the outer circumferential surface of bobbin 110 between mark 114 and flange portion 150.

According to the fourth aspect, positioning can performed based on mark 114 at the time of manufacturing of electroacoustic transducer 100, and the influence of mark 114 on the sound quality of electroacoustic transducer 100 after manufacturing can be almost completely suppressed.

Electroacoustic transducer 100 according to a fifth aspect is electroacoustic transducer 100 according to any one of the first to fourth aspects, further including: connecting components 121 that are electrically connected to opposite end portions of voice coil 120, in which, connecting components 121 are arranged to pass between bobbin 110 and flange portion 150.

According to the fifth aspect, the degree of freedom in the arrangement of connecting components 121, such as the arrangement of connecting components 121 up to a connection terminal, the arrangement of connecting components 121 inside damper 160, and so on, can be improved.

Electroacoustic transducer 100 according to a sixth aspect is electroacoustic transducer 100 according to any one of the first to fourth aspects, further including: connecting components 121 that are electrically connected to opposite ends of voice coil 120, in which, bobbin 110 includes inner component 111, first outer component 112, and second outer component 113 that are cylindrical, first outer component 112 and second outer component 113 being disposed outward of inner component 111 and spaced apart from each other, first outer component 112 being arranged closer to voice coil 120 than second outer component 113 is, second outer component 113 being arranged closer to diaphragm 140 than first outer component 112 is, and connecting components 121 are arranged to pass between inner component 111 and first outer component 112, and to pass between first outer component 112 and second outer component 113.

According to the sixth aspect, the degree of freedom in the arrangement of connecting components 121, such as the arrangement of connecting components 121 up to a connection terminal, the arrangement of connecting components 121 inside damper 160, and so on, can be improved.

A method for manufacturing electroacoustic transducer 100 according to a seventh aspect, is a method for manufacturing electroacoustic transducer 100 according to any one of the first to sixth aspects, and includes: forming damper 160 by filling, with resin, a space between first mold component 201 and second mold component 202 that are disposed sandwiching an entire circumference of flange 150 in a winding axis direction of voice coil 120.

According to the seventh aspect, damper 160 can be connected to bobbin 110 via flange portion 150 without manual work, and thus the connection strength between damper 160 and flange portion 150 can be improved and the position precision of damper 160 with respect to bobbin 110 can be improved. Furthermore, production efficiency of electroacoustic transducer 100 can be improved.

### Further Information about Technical Background to this Application

The disclosure of the following patent application including specification, drawings, and claims is incorporated herein by reference in its entirety: Japanese Patent Application No. 2024-080412 filed on May 16, 2024.

### INDUSTRIAL APPLICABILITY

The present disclosure can be used in electroacoustic transducers, such as a loudspeaker that converts electrical signals into sound, a microphone that converts sound into electrical signals, and so on.

1. An electroacoustic transducer comprising:
a bobbin that is cylindrical;
a voice coil that is wound around one end portion of the bobbin;
a magnetic circuit that includes a magnetic gap in which the voice coil is disposed, the magnetic gap being tubular;
a frame to which the magnetic circuit is attached;
a diaphragm that is connected to the bobbin and the frame;
a flange portion that protrudes outward from an outer circumferential surface of the bobbin, between the voice coil and the diaphragm; and
a damper that is connected to an outer circumferential surface of the flange portion and to the magnetic circuit or the frame.

2. The electroacoustic transducer according to claim 1, wherein
the flange portion is made of paper.

3. The electroacoustic transducer according to claim 1, wherein
an amount by which the flange portion protrudes from the outer circumferential surface of the bobbin is greater than an amount by which the voice coil protrudes from the outer circumferential surface of the bobbin.

4. The electroacoustic transducer according to claim 1, wherein
a mark is provided in an other end portion of the bobbin in a winding axis direction of the voice coil, the other end portion being on an opposite side of the one end portion of the bobbin at which the voice coil is attached, and
the diaphragm is attached to the outer circumferential surface of the bobbin between the mark and the flange portion.

5. The electroacoustic transducer according to claim 1, further comprising:
connecting components that are electrically connected to opposite end portions of the voice coil, wherein
the connecting components are arranged to pass between the bobbin and the flange portion.

6. The electroacoustic transducer according to claim 1, further comprising:
connecting components that are electrically connected to opposite ends of the voice coil, wherein
the bobbin includes an inner component, a first outer component, and a second outer component that are cylindrical, the first outer component and the second outer component being disposed outward of the inner component and spaced apart from each other, the first outer component being arranged closer to the voice coil than the second outer component is, the second outer component being arranged closer to the diaphragm than the first outer component is, and
the connecting components are arranged to pass between the inner component and the first outer component, and to pass between the first outer component and the second outer component.

7. A method for manufacturing the electroacoustic transducer according to claim 1, the method comprising:
forming the damper by filling, with resin, a space between a first mold component and a second mold component that are disposed sandwiching an entire circumference of the flange in a winding axis direction of the voice coil.
